(19) United States
(12) Patent Application Publication
(10) Pub. No.: US 2015/0330457 A1
(43) Pub. Date: Nov. 19, 2015

(54) JOINT STRUCTURE OF YOKE AND SHAFT AND JOINING METHOD THEREFOR

(71) Applicant: YAMADA MANUFACTURING CO., LTD., Kiryuu-shi, (JP)

(72) Inventors: Takayuki KOISO, Isesaki-shi, Gunma (JP); Toru SEKIGUCHI, Isesaki-shi, Gunma (JP)

(73) Assignee: YAMADA MANUFACTURING CO., LTD., Kiryu-shi (JP)

(21) Appl. No.: 14/649,897

(22) PCT Filed: Dec. 17, 2013
(86) PCT No.: PCT/JP2013/083781

§ 371 Date: Jun. 4, 2015

(30) Foreign Application Priority Data
Dec. 18, 2012 (JP) 2012-275590

(51) Int. Cl. F16D 3/26; B29C 45/16; B29C 45/14

(52) U.S. Cl. CPC F16D 3/26; B29C 45/14467; B29C 45/1671; B29C 2045/14868; B29C 2045/14967; B29L 2031/75

(57) ABSTRACT

The purpose of the present invention is to provide a yoke and shaft joint structure with which joint strength of a metal junction of a yoke and shaft that configure a steering device can be obtained with a very simple structure and a very small size, and a joining method therefor. The joint structure is obtained from a yoke (A) having a cylindrical section, a shaft (3) having a joint-side shaft end (31) that is joined by metal to the cylindrical section (2), and a synthetic resin covering (4) that covers the entire circumference of the junctions site of the cylindrical section (2) of the yoke (A) and the joint-side shaft end (31) of the shaft (3). A portion of the synthetic resin covering (4) is filled and solidified in yoke through holes (23) formed in the cylindrical section (2) and shaft through holes (33) formed in the joint-side shaft end (31) of the shaft (3).

### TECHNICAL FIELD

The present invention relates to a joint structure of a yoke and a shaft with which a joint strength of a metal joint of the yoke and shaft constituting a steering device can be obtained with a very simple structure and a very small size, and to a joining method therefor.

### BACKGROUND ART

Structures in which a shaft and a yoke are joined by metal joining such as welding have been disclosed. Patent Literature 1 (Japanese Patent Application Publication No. 2003-65351) representing the related art is summarized hereinbelow by using the reference numerals described in Patent Literature 1. An output shaft 13 and an output shaft yoke 14 are joined by friction welding (see Patent Literature 1, FIG. 6). In the output shaft 13, a serration 19 is formed in the inner circumferential surface of a hollow cylindrical main body of a uniform diameter, and an enlarged-diameter portion 30 is provided integrally with one end portion 13a of the main body (see Patent Literature 1, FIG. 5). The enlarged-diameter portion 30 is formed to be thicker than the main body.

The enlarged-diameter portion 30 is formed in a cylindrical shape, and an outer circumferential surface 30a is formed as a substantially flat round surface. The output shaft 13 and the output shaft yoke 14 represent a shaft that transmit rotation and a universal joint in which the shafts are coupled, and in order to transmit a rotation torque reliably, the joining strength is increased by forming the enlarged diameter portion 30, which is thicker than the main body, at the output shaft 13 and increasing the welding surface area with respect to a base end portion 20 of the output shaft yoke 14.

Patent Literature 1: Japanese Patent Application Publication No. 2003-65351

### DISCLOSURE OF THE INVENTION

Where the diameter of the output shaft 13 in Patent Literature 1 is increased, the base end portion 20 of the output shaft yoke 14 also needs to be increased in diameter to match the enlarged-diameter portion 30, the size and weight of the output shaft 13 and output shaft yoke 14 are increased and the entire steering device is increased in size. Where the shaft and yoke are increased in size, the freedom of design is decreased. For example, a structure in which interference with other parts is avoided should be considered. A technical problem (objective) to be resolved by the present invention is to strengthen the joining site of friction-joined members with a very simple structure and in a compact configuration and to enable very simple manufacture of the joint.

The inventor has conducted a comprehensive study aimed at the resolution of the abovementioned problems. The results obtained demonstrate that the invention as in claim 1 resolves the abovementioned problems by providing a joint structure of a yoke and a shaft, including: a yoke having a cylindrical portion; a shaft having a joint-side shaft end portion which is metal-joined to the cylindrical portion; and a synthetic resin covering that covers an entire circumference of the joining site of the cylindrical portion of the yoke and the joint-side shaft end portion of the shaft, wherein part of the synthetic resin covering is filled and solidified in a yoke passage hole formed in the cylindrical portion and a shaft passage hole formed in the joint-side shaft end portion of the shaft.

The invention as in claim 2 resolves the abovementioned problems by providing the joint structure of a yoke and a shaft according to claim 1, wherein a joining recess formed as a cylindrical cavity is formed in the cylindrical portion, the joint-side shaft end portion of the shaft is inserted into the joining recess, and the shaft passage hole formed in the joint-side shaft end portion of the shaft and the yoke passage hole coincide with the same diametrical central line.

The invention as in claim 3 resolves the abovementioned problems by providing the joint structure of a yoke and a shaft according to claim 1, wherein an outer diameter of the cylindrical portion is equal to a diameter of the joint-side shaft end portion of the shaft, the two portions are abutted against each other and metal-joined, and part of the synthetic resin covering is filled and solidified in the yoke passage hole formed in the cylindrical portion and the shaft passage hole formed in the joint-side shaft end portion of the shaft.

The invention as in claim 4 resolves the abovementioned problems by providing the joint structure of a yoke and a shaft according to any one of claims 1, 2, and 3, wherein a groove is formed along the circumferential direction in the joint-side shaft end portion of the shaft, and part of the synthetic resin covering is filled and solidified in the groove.

The invention as in claim 5 resolves the abovementioned problems by providing a method for joining a yoke and a shaft, the yoke having a cylindrical portion in which a joining recess is formed at one end side in an axial direction, and the shaft having a joint-side shaft end portion which is to be filled into the joining recess of the cylindrical portion, the method comprising: inserting the joint-side shaft end portion of the shaft into the joining recess and metal-joining the joint-side shaft end portion and the joining recess; drilling a passage hole that passes through the cylindrical portion and the joint-side shaft end portion in a straight line; filling a resin into the passage hole via a mold; and forming a synthetic resin covering over an entire circumference of the joining site of the cylindrical portion and the joint-side shaft end portion.

The invention as in claim 6 resolves the abovementioned problems by providing the method for joining a yoke and a shaft according to claim 5, wherein a through hole that communicates with the joining recess, has an inner diameter less than an inner diameter of the joining recess, and is located on the same diametrical central line is formed at the other end side, in the axial direction, of the cylindrical portion, a core is inserted into the through hole so as to reach the inside of the joining recess, the resin is then filled into the passage hole via the mold, the synthetic resin covering is formed over the entire circumference of the joining site of the cylindrical portion and the joint-side shaft end portion, and the core is removed from the through hole. The invention as in claim 7 resolves the abovementioned problems by providing the method for joining a yoke and a shaft according to claim 5 or 6, wherein a groove is formed along the circumferential direction in the joint-side shaft end portion of the shaft, and part of the synthetic resin covering is filled into the groove.

In the invention as in claim 1, the cylindrical portion of the yoke and the joint-side shaft end portion of the shaft are metal-joined, and the synthetic resin covering that covers the entire circumference of the joining site of the cylindrical portion and the joint-side shaft end portion is configured such that part of the synthetic resin covering is filled and solidified in the yoke passage hole formed in the cylindrical portion and the shaft passage hole formed in the joint-side shaft end portion of the shaft. As a result, it is possible to lock the yoke and shaft in the circumferential direction, increase the strength against a bending load, and raise the rigidity.

Further, the synthetic resin covering increases the strength of the yoke-shaft joint in the rotation direction, facilitates the reduction in size of the yoke and shaft portion of the shaft, enables large torque transmission with a compact configuration, and makes it possible to realize those features with a very simple structure, without performing complex processing.

With the invention as in claim 2, the joining recess is formed in the cylindrical portion, and the joint-side shaft end portion of the shaft is inserted into the joining recess. As a result, the yoke and shaft can be aligned in a simple manner, the joint-side shaft end portion is supported by the joining recess in a metal-joined state, and a stronger joint can be obtained. With the invention as in claim 3, because of the structure in which the cylindrical portion and the joint-side shaft end portion of the shaft have equal diameters and the two portions are abutted against each other and metal-joined, the shape of the joining site of the yoke and shaft can be simplified.

With the invention as in claim 4, because of the configuration in which a groove is formed along the circumferential direction in the joint-side shaft end portion of the shaft, and part of the synthetic resin covering is filled and solidified in the groove, the reinforcement of the yoke and shaft in the axial direction can be further enhanced.

With the invention as in claim 5, the joint-side shaft end portion of the shaft is inserted into the joining recess and the shaft is rotated at a high speed inside the joining recess. As a result, metal joining can be performed in a very reliable and easy manner. Further, the passage hole passing through in a straight line can be drilled very efficiently with a tool, such as a drill, in the cylindrical portion and joint-side shaft end portion, and a subsequent operation of filling a resin into the passage hole via a mold can be easily performed.

With the invention as in claim 6, a through hole that communicates with the joining recess, has an inner diameter less than the inner diameter of the joining recess, and is located on the same diametrical central line is formed at the other end side, in the axial direction, of the cylindrical portion. As a result, the yoke can be reduced in weight. Further, a core is inserted into the shaft recess of the joint-side shaft end portion which has been inserted into the joining recess, and a resin is then filled into the passage hole via the mold.

As a result, the molten synthetic resin does not penetrate into the zone occupied by the core in the shaft recess, and where the core is removed from the through hole, an annular portion is configured by the solidified synthetic resin. Therefore, the resin filled into the passage hole can be reinforced to a greater degree and the amount of the synthetic resin which is to be melted can be decreased, thereby reducing cost.

With the invention as in claim 7, a groove is formed along the circumferential direction in the joint-side shaft end portion of the shaft, and part of the synthetic resin covering is filled into the groove. As a result, the yoke and shaft can be reinforced to a greater degree in the axial direction, this reinforcement can be formed at the same time as the synthetic resin covering is formed with the mold, and the operation efficiency can be increased.

### BRIEF DESCRIPTION OF THE DRAWINGS

FIG. 1(A) is a side view illustrating a partial cross section according to the first embodiment of the present invention, FIG. 1(B) is an enlarged view of an (a) portion in FIG. 1(A), and FIG. 1(C) is an enlarged vertical sectional view in which the yoke and shaft are separated.

FIG. 2(A) is a vertical sectional view illustrating the process of inserting the joint-side shaft end portion of the shaft into the joining recess of the yoke in the first embodiment, FIG. 2(B) is a vertical sectional view illustrating the process of fixedly attaching the cylindrical portion of the yoke and the joint-side shaft end portion of the shaft to each other by metal joining (friction welding), and in FIG. 2(C), (1) to (3) are process diagrams illustrating the penetration of burrs, which have been generated in the metal joining (friction welding) process, into the clearance in a (β) portion in FIG. 2(B).

FIG. 3(A) is a vertical sectional view illustrating the process of drilling a passage hole in the metal-joined yoke and shaft, and FIG. 3(B) is a vertical sectional view illustrating the process of attaching a mold and a core to the metal-joined yoke and shaft.

FIG. 4(A) is a vertical sectional view illustrating a state in which a resin is poured into the mold attached to the yoke and shaft, FIG. 4(B) is a vertical sectional view of the yoke and shaft from which the mold and core have been removed, and FIG. 4(C) is a sectional view along the arrows Y1-Y1 in FIG. 4(B).

FIG. 5(A) is a vertical sectional view illustrating the separated yoke and shaft in the second embodiment of the present invention, and FIG. 5(B) is a vertical sectional view illustrating the principal parts in the second embodiment of the present invention.

FIG. 6(A) is a vertical sectional view illustrating the principal parts in the third embodiment of the present invention, and FIG. 6(B) is an enlarged sectional view taken close to the groove of the shaft in a (y) portion in FIG. 6(A).

FIG. 7(A) is a vertical sectional view illustrating the separated yoke and shaft in the fourth embodiment of the present invention, FIG. 7(B) is a vertical sectional view illustrating the process of drilling a passage hole in the yoke and shaft, and FIG. 7(C) is a vertical sectional view illustrating the principal parts in the fourth embodiment.

### BEST MODE FOR CARRYING OUT THE INVENTION

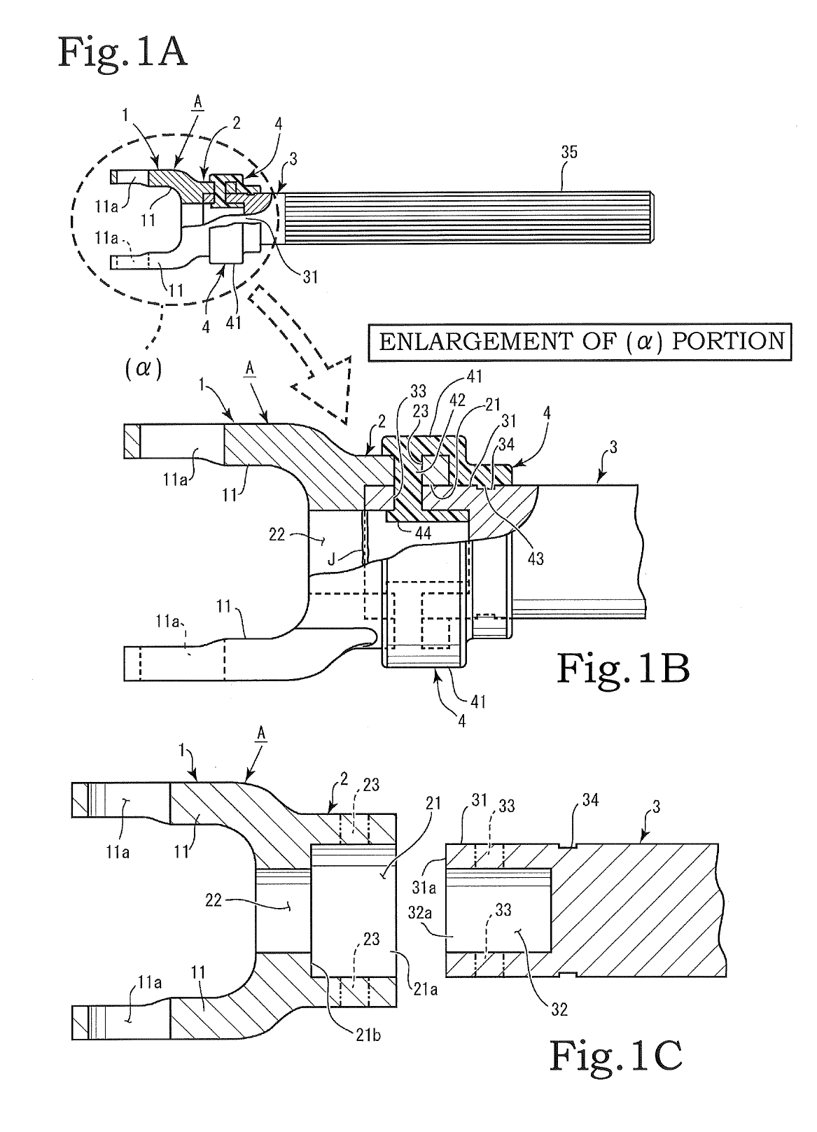

The embodiments of the present invention will be explained hereinbelow with reference to the drawings. The yoke and shaft in the present invention are intermediate shaft members which constitute a steering device for an automobile and are mounted on a steering column to transmit the rotation created by a steering wheel. The configuration in accordance with the present invention is mainly constituted, as depicted in FIG. 1, by a yoke A, a shaft 3, and a synthetic resin covering 4.

The present invention includes a plurality of embodiments, and the explanation thereof is started from the first embodiment. The yoke A is made from a metal, and an aluminum material can be used thereof. The yoke is constituted by a bifurcated portion 1 and a cylindrical portion 2. The bifurcated portion 1 is formed integrally with one end side, in the axial direction, of the cylindrical portion 2. More specifically, the bifurcated portion 1 is constituted by two arm pieces 11.

The two arm pieces 11 are arranged and formed parallel to each other with a spacing larger than the outer diameter of the cylindrical portion 2 from two diametrical ends at one end side, in the axial direction, of the cylindrical portion 2. Through holes 11a for connection are formed in the respective arm pieces 11 (see FIG. 1(B)).

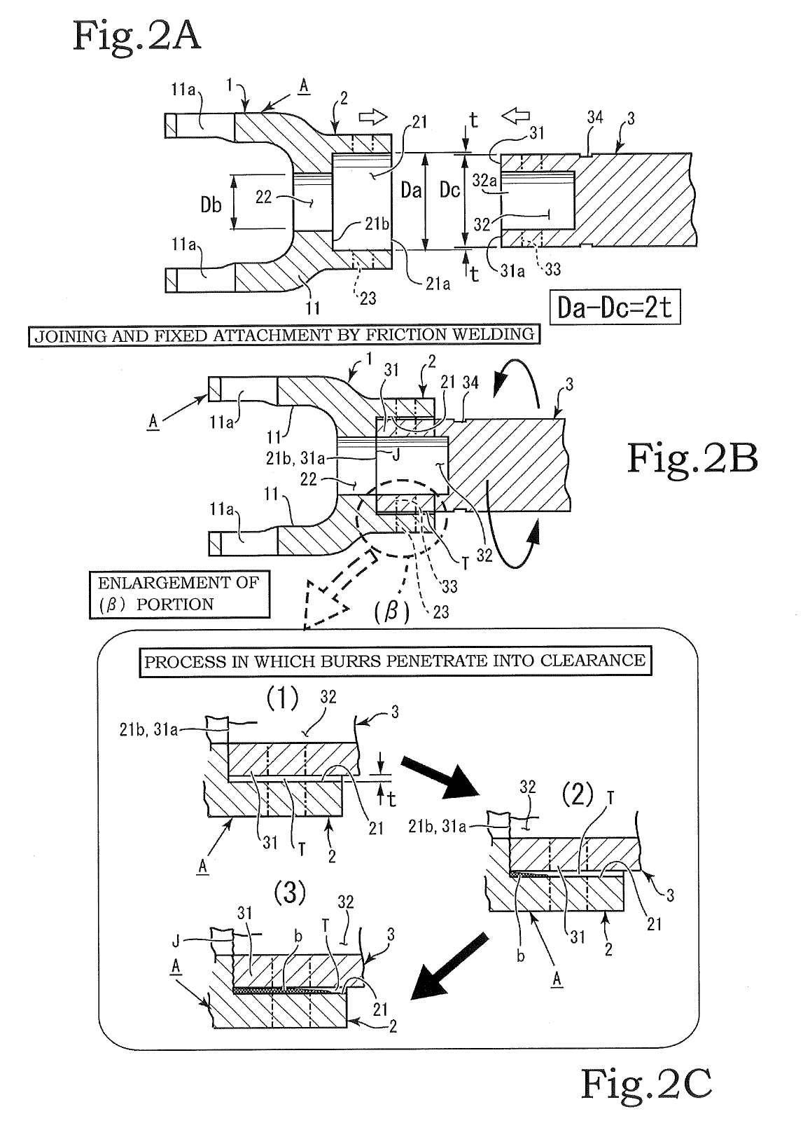

The cylindrical portion 2 is formed in a cylindrical shape which is comparatively short in the axial direction (see FIGS. 1(C), 2(A) or the like). A joining recess 21 having an opening 21a is formed along the axial direction of the cylindrical portion 2 at the other end side, in the axial direction, of the cylindrical portion 2 (the side which is opposite, in the axial direction, to the side where the bifurcated portion 1 is formed).

The joining recess 21 is a depression formed as a cylindrical cavity, and a joint-side shaft end portion 31 of the below-described shaft 3 is to be inserted therein. A bottom surface 21b is formed in the joining recess 21, and the bottom surface 21b is a flat surface perpendicular to the axial direction. The end surface of the joint-side shaft end portion 31 of the shaft 3 which has been inserted into the joining recess 21 abuts upon the bottom surface 21b and friction welding is performed.

Further, a through hole 22 is formed at one end side, in the axial direction, of the cylindrical portion 2 (the side where the bifurcated portion 1 is formed). The through hole 22 is positioned on the same central line as the joining recess 21 and formed such that the inner diameter Db of the through hole 22 is less than the inner diameter Da of the joining recess 21 (see FIG. 2(A)). Further, a yoke passage hole 23 is formed on the outer circumferential side of the cylindrical portion 2. The yoke passage hole 23 is actually drilled after the yoke A and the shaft 3 have been friction joined together.

The shaft 3 is a solid or hollow tube, and the axially end portion thereof which is to be joined to the cylindrical portion 2 is called the joint-side shaft end portion 31. A shaft recess 32 having a shaft opening 32a is formed in a shaft end surface 31a of the joint-side shaft end portion 31 (see FIG. 1(C)). The shaft recess 32 is a cylindrical cavity which is formed such that the inner diameter thereof is equal (inclusive of substantially equal) to the inner diameter of the through hole 22 of the cylindrical portion 2.

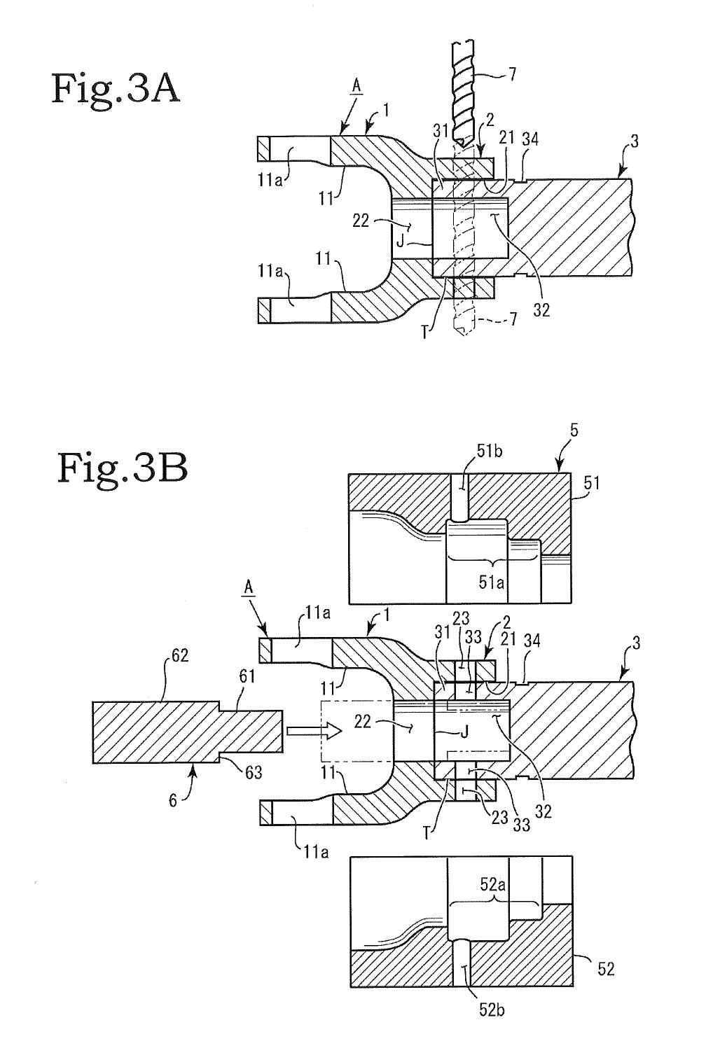

When the joint-side shaft end portion 31 is inserted into the joining recess 21 of the cylindrical portion 2 of the yoke A, the through hole 22 and the shaft recess 32 constitute a cylindrical cavity extending in the axial direction while the diametrically central lines of the through hole and shaft recess coincide (see FIG. 3(A)). A shaft passage hole 33 is formed in the joint-side shaft end portion 31. The shaft passage hole 33 is actually drilled after the yoke A and the shaft 3 have been friction joined together (see FIG. 3(A)).

A groove 34 is formed in the circumferential direction in the joint-side shaft end portion 31 (see FIG. 1(C)). The groove 34 serves to be filled with part of the below-described synthetic resin covering 4 so that the synthetic resin covering 4 could be stronger secured to the shaft 3. Further, a rotation transmitting portion 35, such as a spline or serration, is formed in an axial region of the shaft 3 outside the joint-side shaft end portion 31 (see FIG. 1(A)).

The process of joining the yoke A and the shaft 3 together is described below. Initially, the joint-side shaft end portion 31 of the shaft 3 is inserted into the joining recess 21 of the yoke A, and the bottom surface 21b of the joining recess 21 and the shaft end surface 31a of the joint-side shaft end portion 31 are brought into contact with each other and rotated relative to each other under applied pressure (FIGS. 2(A) and 2(B)). The two end portion are melted, fused, and joined together by the heat generated by friction in this process.

In the process of friction welding of the joining recess 21 of the cylindrical portion 2 and the joint-side shaft end portion 31 of the shaft 3, curled burrs are generated between the joining recess 21 and the joint-side shaft end portion 31. After the joining is completed, the inner circumferential surfaces of the through hole 22 of the cylindrical portion 2 of the yoke A and the through hole 31 of the shaft 3 are subjected to machining, and the burrs generated on the inner circumferential surfaces are removed by the machining.

In this case, the diameter of the joint-side shaft end portion 31 of the shaft 3 is set to be less than the inner diameter of the joining recess 21 and set such that a clearance T appears between the joint-side shaft end portion 31 and the joining recess 21. More specifically, the joint-side shaft end portion 31 has an outer diameter Dc with respect to the inner diameter Da of the joining recess 21, and the size of the clearance T is 2t. The clearance T is a sum of the gaps appearing at both sides, in the diametrical direction, of the joint-side shaft end portion 31.

As a result, the inner diameter Da of the joining recess 21, the outer diameter Dc of the joint-side shaft end portion 31, and the size 2t of the clearance T satisfy the following relationship.

Da−Dc=2t

Therefore, the gap size of either of the joint-side shaft end portion 31 and the joining recess 21 is t. This size t is set to about several millimeters (see (1) in FIGS. 2(A) and 2(C)). Parts of the burrs b generated in the friction joining process gradually penetrate into the clearance T (see (2) and (3) in FIG. 2(C)). Thus, since parts of the burrs generated by the friction welding penetrate into the gap T, the burrs b are prevented from protruding from the joining site of the yoke A and the shaft 3. The burrs b are also jammed into the clearance T, and the yoke A and the shaft 3 are very strongly joined together.

Where friction welding of the cylindrical portion 2 of the yoke A and the joint-side shaft end portion 31 of the shaft 3 is completed, the yoke passage hole 23 and the shaft passage hole 33 are drilled in the cylindrical portion 2 and the joint-side shaft end portion 31 (see FIG. 3(A)). More specifically, the yoke passage hole 23 and the shaft passage hole 33 are drilled to coincide with the same diametrically central line so as to pass through the diametrical center of the cylindrical portion 2 and the joint-side shaft end portion 31. The reference numeral 7 stands for a drill for drilling the yoke passage hole 23 and the shaft passage hole 33.

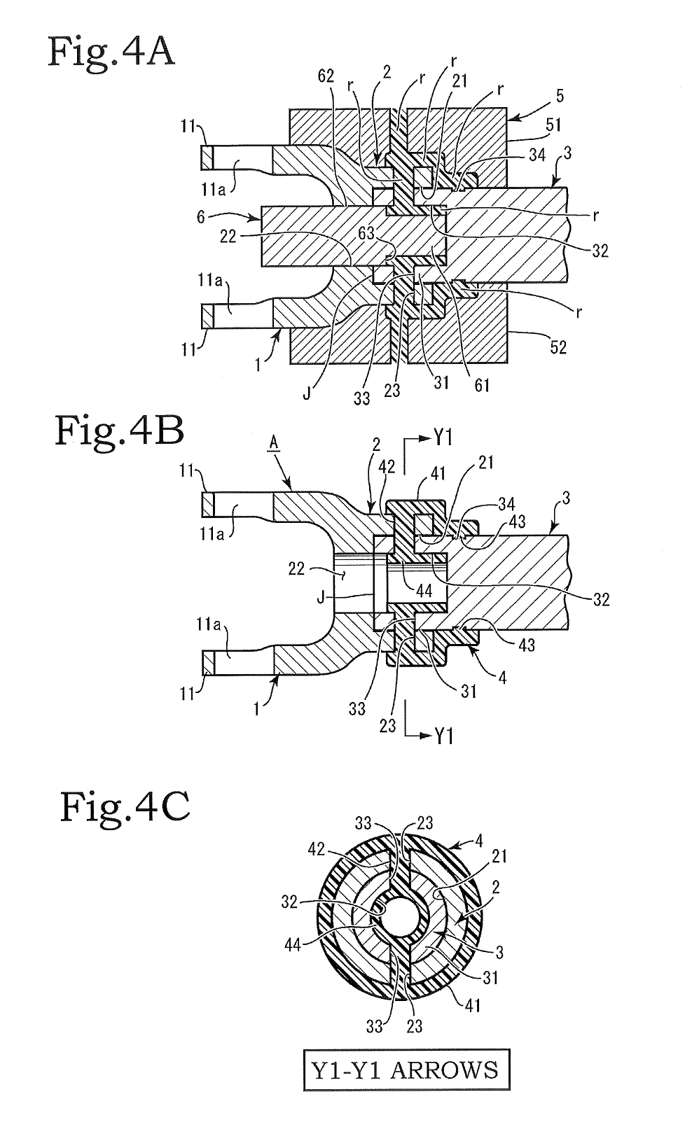

Then, a mold 5 is disposed such as to cover the entire circumference of the joining site of the cylindrical portion 2 and the joint-side shaft end portion 31. The mold 5 is divided in two and constituted by an upper mold 51 and a lower mold 52 (see FIG. 3(B)). The mold serves to form the synthetic resin covering 4 that covers with a synthetic resin the entire circumference of the joining site of the yoke A and the shaft 3 (see FIG. 4(A)).

Cavities 51a, 52a the and pouring ports 51b, 52b for forming the synthetic resin covering 4 are formed in the upper mold 51 and lower mold 52, respectively, and the upper mold 51 and the lower mold 52 are disposed such that the cavities 51a, 52a are positioned at the joining site of the yoke A and the shaft 3, more specifically, at the joining site of the cylindrical portion 2 and the joint-side shaft end portion 31 (see FIG. 3(B)).

A core 6 is inserted from the through hole 22 of the yoke A. The core 6 is formed in a cylindrical shape and constituted by a small-diameter axial portion 61, a large-diameter axial portion 62, and a step 63 (see FIG. 3(B)). The step 63 is an annular flat surface perpendicular to the axial direction which is the longitudinal direction. The diameter of the large-diameter axial portion 62 is slightly less than the inner diameter of the through hole 22 of the cylindrical portion 2 and the shaft recess 32 and preferably set such as to enable the insertion practically without a gap between the two parts.

Inside the shaft recess 32 of the shaft 3, the small-diameter shaft portion 61 of the core 6 is set such as to cross the diametrical central line of the shaft passage hole 33 (see FIG. 3(B)). The small-diameter axial portion 61 and part of the large-diameter axial portion 62 enter the shaft recess 32. At this time, the distal end surface of the small-diameter axial portion 61 abuts against the bottom surface of the shaft recess 32 (see FIG. 4(A)).

The molten synthetic resin r flows in from the pouring port 51b of the upper mold 51 (or the pouring port 52b of the lower mold 52), and the synthetic resin flows from the cavities 51a, 52a into the yoke passage hole 23 and the shaft passage hole 33 (see FIG. 4(A)). Further, since the small-diameter axial portion 61 and part of the large-diameter axial portion 62 of the core 6 are positioned inside the shaft recess 32, the molten synthetic resin r does not enter this space. The molten synthetic resin r is also filled into a groove 34 formed in the joint-side shaft end portion 31 of the shaft 3 (see FIG. 4(A)).

The synthetic resin covering 4 is formed in the joining site of the yoke A and shaft 3 by removing the mold 5 and the core 6 from the joining site after the synthetic resin poured into the mold 5 has solidified. The synthetic resin covering 4 is constituted by a cover portion 41 that covers the joining site on the cylindrical portion 2 of the yoke A and the joint-side shaft end portion 31 of the shaft 3, a joining pin-shaped piece 42 formed by filling and solidifying in the yoke passage hole 23 and the shaft passage hole 33, a fixing protruding piece 43 formed by filling and solidifying in the groove 34, and an annular fixing portion 44 formed along the inner circumferential surface in the shaft recess 32 (see FIGS. 4(B) and 4(C)).

The joining pin-shaped piece 42 of the synthetic resin covering 4 further increases the reinforcement of the yoke A and shaft 3 in the rotation direction (see FIG. 4(B)). Since the fixing protruding piece 43 is filled into the groove 34 of the shaft 3, the reinforcement of the synthetic rein covering 4 and the shaft 3 in the axial direction can be enhanced (see FIG. 4(B)).

The annular fixing portion 44 can reinforce both ends, in the axial direction, of the joining pin-shaped piece 42 together with the cover portion 41. The hollow annular fixing portion 44 can reduce the amount of the synthetic resin (see FIG. 4(C)). Further, the burrs b which have penetrated into the clearance T are encapsulated and fixed inside the clearance T by the synthetic resin covering 4. As a result, the burrs b are prevented from being scattered to the outside of the clearance T.

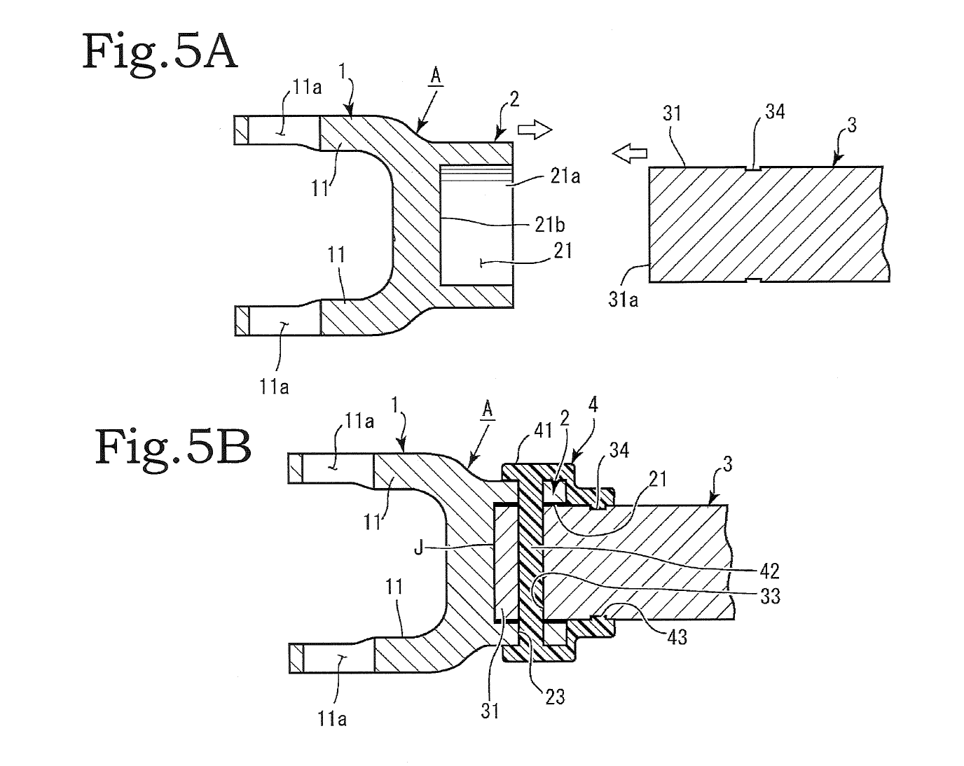

The second embodiment of the present invention will be explained hereinbelow with reference to FIG. 5. In the second embodiment of the present invention, in the cylindrical portion 2 of the yoke A, the through hole 22 is not formed only in the joining recess 21. Further, the shaft recess 32 is not formed in the shaft 3 (see FIG. 5(A)).

In this embodiment, the joint-side shaft end portion 31 of the shaft 3 is inserted into the joining recess 21 of the yoke A, and friction welding is performed in a state in which the shaft end surface 31a and the bottom surface 21b are abutted against each other. After the friction welding has been performed, the yoke passage hole 23 and the shaft passage hole 33 are drilled in the cylindrical portion 2 and the joint-side shaft end portion 31.

In this case, the joint-side shaft end portion 31 is a solid part, and the shaft passage hole 33 becomes a through hole passing through in the diametrical direction. In the same manner as in the first embodiment of the present invention, the upper mold 51 and the lower mold 52 of the mold 5 are disposed at the joining site of the cylindrical portion 2 and the joint-side shaft end portion 31, and the molten synthetic resin is poured thereinto. In the second embodiment, the core 6 is not used (see FIG. 5(B)).

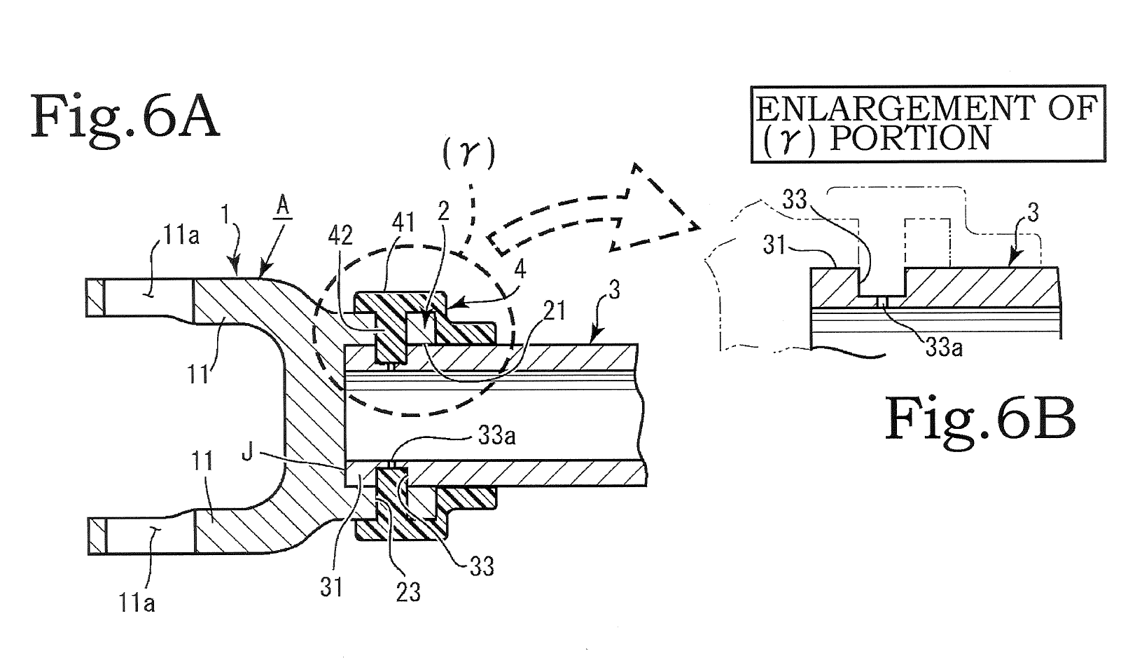

The third embodiment of the present invention will be explained hereinbelow with reference to FIG. 6. In the third embodiment of the present invention, the shaft 3 is a hollow shaft. Further, in the yoke A, the through hole 22 is not formed only in the joining recess 21 in the cylindrical portion 2, in the same manner as in the second embodiment (see FIG. 6(A)).

In this embodiment, the shaft passage hole 33 which is formed in the joint-side shaft end portion 31 of the shaft 3 is configured not to pass through to the hollow portion inside the shaft 3, and a small-diameter hole 33a is formed in the bottom surface thereof (see FIG. 6(B)). As a result, where the molten synthetic resin is filled into the shaft passage hole 33, the air escapes from the small-diameter hole 33a and the filling can be reliably performed.

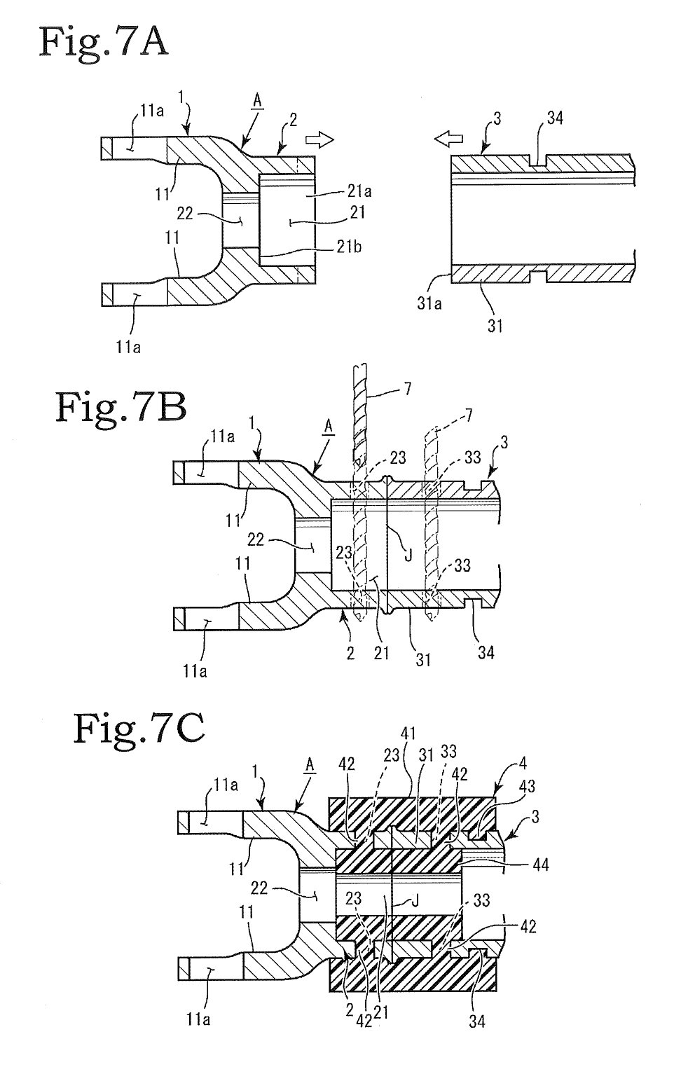

The fourth embodiment of the present invention will be explained hereinbelow with reference to FIG. 7. In the fourth embodiment of the present invention, the diameter of the cylindrical portion 2 of the yoke A is the same as (equal to) the diameter of the joint-side shaft end portion 31 of the shaft 3 (see FIG. 7(A)). The “same as”, as referred to herein, is inclusive of substantially the same as (equal to). The cylindrical portion 2 and the joint-side shaft end portion 31 are joined and friction welded together in a state in which the end portions thereof are mated together.

The yoke passage hole 23 and the shaft passage hole 33 are formed (drilled) with a drill 7, or the like, at mutually different positions, instead of being formed at the same straight line orthogonal to the axial direction as in the first to third embodiments (see FIG. 7(B)). Further, the synthetic resin covering 4 is formed such that the cover portion 41 covers both the yoke passage hole 23 and the shaft passage hole 33. Further, an annular fixing portion 44 is formed inside the joining recess 21 of the yoke A and the shaft recess 32 of the shaft 3, and the synthetic resin covering 4 is further reinforced (see FIG. 7(C)).

### EXPLANATION OF REFERENCE NUMERALS

A . . . yoke; 2 . . . cylindrical portion; 21 . . . joining recess; 21b . . . bottom surface; 22 . . . through hole; 23 . . . yoke passage hole; 3 . . . shaft; 31 . . . joint-side shaft end portion; 32 . . . shaft recess; 33 . . . shaft passage hole; 34 . . . groove; 4 . . . synthetic resin covering; 5 . . . mold; 6 . . . core.

1. A joint structure of a yoke and a shaft, comprising: a yoke having a cylindrical portion; a shaft having a joint-side shaft end portion which is metal joined to the cylindrical portion; and a synthetic resin covering that covers an entire circumference of the joining site of the cylindrical portion of the yoke and the joint-side shaft end portion of the shaft, wherein part of the synthetic resin covering is filled and solidified in a yoke passage hole formed in the cylindrical portion and a shaft passage hole formed in the joint-side shaft end portion of the shaft.

2. The joint structure of a yoke and a shaft according to claim 1, wherein a joining recess formed as a cylindrical cavity is formed in the cylindrical portion, the joint-side shaft end portion of the shaft is inserted into the joining recess, and the shaft passage hole formed in the joint-side shaft end portion of the shaft and the yoke passage hole coincide with the same diametrical central line.

3. The joint structure of a yoke and a shaft according to claim 1, wherein an outer diameter of the cylindrical portion is equal to a diameter of the joint-side shaft end portion of the shaft, the two portions are abutted against each other and metal-joined, and part of the synthetic resin covering is filled and solidified in the yoke passage hole formed in the cylindrical portion and the shaft passage hole formed in the joint-side shaft end portion of the shaft.

4. The joint structure of a yoke and a shaft according to claim 1, wherein a groove is formed along the circumferential direction in the joint-side shaft end portion of the shaft, and part of the synthetic resin covering is filled and solidified in the groove.

5. A method for joining a yoke and a shaft, the yoke having a cylindrical portion in which a joining recess is formed at one end side in an axial direction, and the shaft having a joint-side shaft end portion which is to be filled into the joining recess of the cylindrical portion, the method comprising: inserting the joint-side shaft end portion of the shaft into the joining recess and metal-joining the joint-side shaft end portion and the joining recess; drilling a passage hole that passes through the cylindrical portion and the joint-side shaft end portion in a straight line; filling a resin into the passage hole via a mold; and
forming a synthetic resin covering over an entire circumference of the joining site of the cylindrical portion and the joint-side shaft end portion.

6. The method for joining a yoke and a shaft according to claim 5, wherein a through hole that communicates with the joining recess, has an inner diameter less than an inner diameter of the joining recess, and is located on the same diametrical central line is formed at the other end side, in the axial direction, of the cylindrical portion, a core is inserted into the through hole so as to reach the inside of the joining recess, the resin is then filled into the passage hole via the mold, the synthetic resin covering is formed over the entire circumference of the joining site of the cylindrical portion and the joint-side shaft end portion, and the core is removed from the through hole.

7. The method for joining a yoke and a shaft according to claim 5, wherein a groove is formed along the circumferential direction in the joint-side shaft end portion of the shaft, and part of the synthetic resin covering is filled into the groove.
